(19) United States
(12) Patent Application Publication
(10) Pub. No.: US 2025/0111248 A1
(43) Pub. Date: Apr. 3, 2025

(54) APPARATUS, METHOD, AND COMPUTER PROGRAM PRODUCT FOR APPLYING TRAINED MACHINE LEARNING MODELS TO OUTPUT PAST INCIDENT INSIGHT INTERFACE COMPONENTS TO AN INCIDENT ALERT MANAGEMENT USER INTERFACE

(71) Applicant: ATLASSIAN PTY LTD., Sydney (AU)

(72) Inventors: Shashank RAO, Noida (IN); Atri MANDAL, Gunjur (IN); Divya PADMANABHAN, Navi Mumbai (IN); Rahul SINGH, Gurugram (IN); Uday KHANNA, Gurgaon (IN)

(21) Appl. No.: 18/478,240

(22) Filed: Sep. 29, 2023

(51) Int. Cl. G06N 5/022; G06N 5/01

(52) U.S. Cl. CPC G06N 5/022; G06N 5/01

(57) ABSTRACT

Apparatus, methods, and computer program products for outputting a past incident insight interface component in a software monitoring data management system are provided. An apparatus may detect a past incident insight interface component request; identify a past incident candidate data object set based on a current incident data object; determine a primary ranking of the past incident candidate data object set or a subset thereof; determine one or more subsequent rankings of the primarily ranked past incident candidate data objects of the past incident candidate data object set or the subset thereof; generate a past incident insight interface component comprising a listing of a past incident candidate data object suggestion set, the past incident candidate data object suggestion set listing one or more of the subsequently ranked past incident candidate data objects; and output the past incident insight interface component for rendering to an incident alert management user interface.

### BACKGROUND

Various systems and software management platforms provide incident management tools to monitor and generate incident alerts associated with tracking, addressing, and managing possible incidents associated with a complex software application framework. Applicant has identified a number of deficiencies and problems associated with existing methods, apparatuses, and systems for incident management in complex software application frameworks which may have dynamic and evolving service/microservice topographies, such as an enterprise software platform. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for efficiently outputting a past incident insight interface component to an incident alert management user interface in a software monitoring data management system.

In accordance with some exemplary embodiments of the present disclosure, an example apparatus is provided for outputting a past incident insight interface component in a software monitoring data management system. In some embodiments, the apparatus may comprise at least one processor and at least one memory including program code, the at least one memory and the program code configured to, with the at least one processor, cause the apparatus to at least detect a past incident insight interface component request in response to user interaction with a software monitoring data management system, wherein the past incident insight interface component request is associated with a current incident data object; identify a past incident candidate data object set based on the current incident data object; determine a primary ranking of the past incident candidate data object set or a subset thereof; determine one or more subsequent rankings of the primarily ranked past incident candidate data objects of the past incident candidate data object set or the subset thereof; generate a past incident insight interface component comprising a listing of a past incident candidate data object suggestion set, the past incident candidate data object suggestion set listing one or more of the subsequently ranked past incident candidate data objects; and output the past incident insight interface component for rendering to an incident alert management user interface of a computing device associated with the past incident insight interface component request.

In some embodiments, the past incident insight interface component is configured to expose a first or summary level of information for at least a selected subsequently ranked past incident candidate data object of the past incident candidate data object suggestion set. In certain embodiments, the first or summary level of information comprises one or more of an incident title, a team member identifier, a creation date, an incident identifier, or a visual emphasis element associated with a priority of the selected subsequently ranked past incident candidate data object. In still some further embodiments, the program code is further configured to, with the at least one processor, cause the apparatus to at least receive a team member data object associated with a selected subsequently ranked past incident candidate data object, wherein the team member data object is based on user interaction with the team member identifier rendered in association with the selected subsequently ranked past incident candidate data object, generate a notification in response to receiving the team member data object; and transmit the notification to a computing device associated with the team member identifier.

In some embodiments, the past incident insight interface component is configured to expose a second or detailed level of information for at least one of the subsequently ranked past incident candidate data objects of the past incident candidate data object suggestion set. In certain embodiments, the second or detailed level of information comprises one or more of a faulty service identifier, an affected product identifier, or a link to a post incident report associated with the at least one subsequently ranked past incident candidate data object.

In some embodiments, the past incident insight interface component comprises one or more feedback actuator buttons associated with at least one of the subsequently ranked past incident candidate data objects, the one or more feedback actuator buttons configured for user interaction. In certain embodiments, the program code is further configured to, with the at least one processor, cause the apparatus to at least receive one or more user feedback data objects associated with the at least one of the subsequently ranked past incident candidate data objects, wherein the one or more user feedback objects are based on user interaction with at least one of the one or more feedback actuator buttons; store the one or more user feedback data objects in a database; and continually refine one or more machine learning models via a positive feedback loop based on the stored one or more user feedback data objects.

In some embodiments, identifying the past incident candidate data object set based on the current incident data object comprises identifying one or more incident categories of the current incident data object; accessing a plurality of past incident data objects; filtering the plurality of past incident data objects based on at least the identified one or more incident categories of the current incident data object; and identifying the past incident data objects associated with the same incident category(ies) as the identified one or more incident categories of the current incident data object as the past incident candidate data object set. In certain embodiments, identifying the one or more incident categories of the current incident data object comprises causing input of the plurality of past incident data objects to an incident categorization machine learning model, the incident categorization machine learning model generating a plurality of incident categories based on the plurality of past incident data objects; extracting at least an incident title from the current incident data object; and associating one or more incident categories of the plurality of incident categories with the current incident data object based at least in part on the extracted incident title. In still some further embodiments, the incident categorization machine learning model comprises a clustering machine learning model in accordance with one or more clustering algorithms.

In some embodiments, determining the primary ranking of the past incident candidate data object set or a subset thereof comprises determining the primary ranking of the past incident candidate data object subset based on at least a relevance score of each past incident candidate data object of the past incident candidate data object subset. In certain embodiments, determining the primary ranking of the past incident candidate data object subset based on at least the relevance score of each past incident candidate data object of the past incident candidate data object subset comprises determining a similarity score, as compared to the current incident data object, for each past incident candidate data object of the past incident candidate data object set; comparing the similarity score for each past incident candidate data object of the past incident candidate data object set to a predetermined threshold; determining the past incident candidate data object subset, wherein the past incident candidate data object subset comprises the past incident candidate data objects of the past incident candidate data object set having similarity scores that satisfy the predetermined threshold; determining a recency score for each past incident candidate data object of the past incident candidate data object subset; and determining the relevance score for each past incident candidate data object of the past incident candidate data object subset.

In some further embodiments, the relevance score for each past incident candidate data object is an aggregate of the similarity score and the recency score of the past incident candidate data object.

In some embodiments, determining the one or more subsequent rankings of the primarily ranked past incident candidate data objects comprises: extracting one or more incident attributes from each of the current incident data object and the primarily ranked past incident candidate data objects; determining an updated relevance score for each of the primarily ranked past incident candidate data objects; and determining the one or more subsequent rankings of the primarily ranked past incident candidate data objects of the past incident candidate data object subset based on at least the updated relevance score of each past incident candidate data object. In certain embodiments, determining the updated relevance score for each of the primarily ranked past incident candidate data object comprises inputting the extracted incident attributes to a decision tree-based ranker machine learning model that is trained to output the updated relevance scores.

In accordance with some exemplary embodiments of the present disclosure, an example method for outputting a past incident insight interface component in a software monitoring data management system comprises detecting a past incident insight interface component request in response to user interaction with the software monitoring data management system; identifying a past incident candidate data object set; determining a primary ranking of the past incident candidate data object set or a subset thereof; determining one or more subsequent rankings of the primarily ranked past incident candidate data objects of the past incident candidate data object set or the subset thereof; generating a past incident insight interface component comprising a listing of a past incident candidate data object suggestion set; and outputting the past incident insight interface component for rendering to an incident alert management user interface of a computing device associated with the past incident insight interface component request.

In some embodiments, determining the primary ranking of the past incident candidate data object set or a subset thereof is based on at least a relevance score of each past incident candidate data object of the past incident candidate data object subset, the method further comprising determining a similarity score, as compared to the current incident data object, for each past incident candidate data object of the past incident candidate data object set; comparing the similarity score for each past incident candidate data object of the past incident candidate data object set to a predetermined threshold; determining the past incident candidate data object subset, wherein the past incident candidate data object subset comprises the past incident candidate data objects of the past incident candidate data object set having similarity scores that satisfy the predetermined threshold; determining a recency score for each past incident candidate data object of the past incident candidate data object subset; and determining the relevance score for each past incident candidate data object of the past incident candidate data object subset.

In some embodiments, determining the one or more subsequent rankings of the primarily ranked past incident candidate data objects comprises extracting one or more incident attributes from each of a current incident data object and the primarily ranked past incident candidate data objects; determining an updated relevance score for each of the primarily ranked past incident candidate data objects; and determining the one or more subsequent rankings of the primarily ranked past incident candidate data objects of the past incident candidate data object subset based on at least the updated relevance score of each past incident candidate data object.

In accordance with some exemplary embodiments of the present disclosure, an example computer program product for outputting a past incident insight interface component in a software monitoring data management system is provided, the computer program product comprising at least one non-transitory computer-readable storage medium having computer-readable program code portions stored therein, the computer-readable program code portions comprising an executable portion configured to detect a past incident insight interface component request in response to user interaction with a software monitoring data management system, wherein the past incident insight interface component request is associated with a current incident data object; identify a past incident candidate data object set based on the current incident data object; generate a past incident insight interface component comprising a listing of a past incident candidate data object suggestion set, the past incident candidate data object suggestion set listing one or more ranked past incident candidate data objects; and output the past incident insight interface component for rendering to an incident alert management user interface of a computing device associated with the past incident insight interface component request.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates a block diagram of an example enterprise software platform system architecture within which at least some embodiments of the present invention may operate.

FIG. 2 depicts a schematic block diagram of computing components of an example incident management server structured in accordance with an example embodiment of the present disclosure.

FIG. 3 depicts a system diagram representing example dependencies between computing system services of a computing environment in accordance with an example embodiment of the present disclosure.

FIGS. 4A and 4B each illustrate past incident insight interface component structured in accordance with various embodiments of the present disclosure.

FIG. 5 illustrates an example past incident insight interface component rendered to an example incident alert management user interface, each structured in accordance with example embodiments of the present disclosure.

FIG. 6A depicts a flowchart diagram of an example process for outputting a past incident insight interface component in a software monitoring data management system in accordance with an example embodiment of the present disclosure.

FIG. 6B illustrates a signal diagram of an example data flow in accordance with an example embodiment of the present disclosure.

FIG. 7 depicts a flowchart diagram of an example process for identifying one or more incident category(ies) of a current incident data object in accordance with an example embodiment of the present disclosure.

FIG. 8 depicts a flowchart diagram of an example process for identifying a past incident candidate data object set in accordance with an example embodiment of the present disclosure.

FIG. 9 depicts a flowchart diagram of an example process for determining a primary ranking of a past incident candidate data object set or a subset thereof in accordance with an example embodiment of the present disclosure.

FIG. 10 depicts a flowchart diagram of an example process for determining one or more subsequent rankings of primarily ranked past incident candidate data objects in accordance with an example embodiment of the present disclosure.

FIG. 11 depicts a flowchart diagram of an example process for retraining one or more machine learning models based on feedback from one or more users in accordance with an example embodiment of the present disclosure.

FIG. 12 depicts a flowchart diagram of an example process for generating and transmitting a notification is provided in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to address technical problems associated with enabling efficient and reliable identification of past similar incidents in a dynamic and evolving universe of interdependent service/microservice topographies in order to address an ongoing incident associated with an enterprise software platform, further allowing incident managers to manage and address incidents with a more complete view of the incident across the totality of such a complex software application framework.

The complexity of enterprise software platforms has matured to a degree that there are now more potential failure points than ever. Many enterprise software platforms comprise one or more types of software applications, for example, monolithic software applications and/or service-oriented software applications. That is, an enterprise software platform may be a complex software application framework that is typically characterized by large networks of interdependent services and microservices that support a myriad of software features and software applications. For example, a given service-oriented platform alone could support hundreds of software applications and each software application may include a number of features, such that the given service-oriented platform alone could support hundreds of thousands of features, with many features (e.g., user authentication features) shared between multiple software applications. Those applications and features could be supported by thousands of services and microservices that exist in vast and ever-changing interdependent layers. Indeed, some large enterprise software platforms may be comprised of topologies of 1,500 or more interdependent services and microservices. Such complex enterprise software platforms are nimble, highly configurable, and enable robust collaboration and communication between users at the individual, team, and enterprise level.

Adding to this complexity is the fact that at any given time, a great number of software development teams may be constantly, yet unexpectedly, releasing code updates that change various software services, launch new software services, change existing features of existing software applications, add new software applications, add new features to existing software applications, and/or the like. The dynamic universe of service/microservice topographies is constantly changing, even between software application sessions. Indeed, a first session of a software application initiated on Monday may be dependent on 1,002 services or microservices while a second session of the same software application initiated on Wednesday may be dependent on 1,014 services or microservices, and only 887 of those services or microservices may be the same. Still further complexity is added by the fact that a vast number of hardware and software components, each with their own operational conditions, security settings, and the like, may be broken, breached, or otherwise compromised.

During operation of such an enterprise software platform, any of a myriad of incidents may occur. The impact of an incident on an enterprise software platform can be devastating. Some estimates suggest that major incidents can cost an organization $300,000 per hour that an enterprise software platform is down. To aid in the discovery of alerts and incidents, an important component of software management is an alert monitoring and incident management tool, which involves monitoring and generating incident alerts for tracking and management by one or more incident managers. For example, individual software applications or software services may be configured to generate incident alerts (e.g., incident data objects) that describe a maintenance-critical state of a corresponding software application or software service and an alert monitoring and incident management tool is a software service that is configured to monitor a complex software platform and detect such software monitoring data objects such as alerts, cautions, problems, errors, issues, incidents, or the like. Example software monitoring data management systems that comprise such alert monitoring service and incident management tools may include the Opsgenieß incident management system by Atlassian® and/or Jira Service Management® by Atlassian®.

Often, administrators, engineers, and/or other users are deployed to attempt to fix an underlying issue in the computing system service that is associated with the incident. Resolving such incidents, however, can be time consuming, may be resource intensive, and may require undesirable system or service downtime. In this regard, the inventors have determined that it is desirable to be able to identify past incidents that are similar to a newly generated incident alert in order to provide incident insight recommendations that may provide assistance to an incident manager tasked with resolving the newly generated incident alert. Determining such recommendations presents technological challenges in such complex software application frameworks due to the sheer number of software applications, services, and micro-services as well as the ever-changing dynamic service/microservice topographies and interdependencies. Various embodiments of the present disclosure address technical problems associated with enabling efficient and reliable identification of past similar incidents in such a dynamic and evolving universe of service/microservice topographies and interdependencies in order to address an ongoing incident associated with an enterprise software platform, further allowing incident managers to manage and address incidents with a more complete view of the incident across the totality of a complex software application frameworks.

One objective of the present disclosure is to enable the collection of incident data objects (e.g., incidents, alerts, etc.) from one or more various complex software application frameworks. Example embodiments of the present disclosure may include detecting a past incident insight interface component request in response to user interaction with a software monitoring data management system, wherein the past incident insight interface component request is associated with a current incident data object. A current incident data object may comprise information, text, and/or other media used to describe the operating functionality and/or status of an enterprise software platform or a constituent service or microservice. Such operating functionality may include indicators regarding the enterprise software platform's performance (e.g., whether the complex platform and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.).

A further objective of the present disclosure is to enable categorization of such incidents and alerts. In some embodiments, a current incident data object may comprise one or more of an incident title or an incident description. An incident categorization determination may be performed in order to develop a general understanding of the intent of the current incident data object. The inventors have determined that because the varied and expansive data associated with incident management in complex software application frameworks is not necessarily comparable or identifiable by a human, it would be advantageous to leverage artificial intelligence and train one or more machine learning models with such dissimilar data in order to determine incident categorization in some embodiments, for example. Such one or more incident categorization machine learning models may thereby inform the incident categorization determination in order to provide insight to the incident managers. In some embodiments, the incident title of the current incident data object may be used with a natural language processing machine learning model for such incident categorization determination. In some embodiments, the natural language processing machine learning model may use vector searching. An example of a natural language model that can be used to process natural language data associated with an incident alert is a sentence encoder machine learning model.

The past incident candidate data objects associated with the one or more identified incident categories may be culled or associated with a past incident corpus (e.g., past incident candidate data object set) while the past incident candidate data objects not associated with the one or more identified incident categories may be disregarded with respect to the current incident data object. The inventors have determined that such past incident candidate filtering may be desirable and advantageous in order to improve the relevance of the past incident suggestions while also reducing search latency due to the reduced search space.

In some embodiments, a primary ranking of the past incident candidate data objects may be determined based on a relevance score of each past incident candidate data object of the past incident candidate data object set. For example, a relevance score may be based on an aggregate of a similarity score and a recency score for each past incident candidate data object, wherein the similarity score is determined based on a comparison of the incident title of the current incident data object to the incident title of each past incident candidate data object and the recency score is determined based on a creation timestamp of each past incident candidate data object.

Subsequent to the primary ranking, in some embodiments, one or more subsequent rankings of the ranked past incident candidate data objects may be determined based on one or more optional incident attributes culled from the current incident data object and the past incident candidate data objects in order to more accurately identify past incident candidate data objects that are more similar or relevant to the current incident data object. For example, in some embodiments, the optional incident attributes may include one or more of a faulty service identifier, a service dependency of the faulty service identifier (e.g., a team member identifier), an incident description, an incident priority level, a presence or an absence of a post incident report (PIR), a presence or an absence of root cause analysis (RCA), or the like. In some embodiments, such primary and subsequent rankings may be performed via one or more candidate ranking machine learning models. In some embodiments, a past incident insight interface component is generated comprising a past incident candidate data object suggestion set which lists one or more of the subsequently ranked past incident candidate data objects (e.g., a past incident data object suggestion set) and the past incident insight interface component is outputted for rendering to an incident alert management user interface (e.g., associated with the incident manager).

In some embodiments, one or more of the machine learning model(s) may be continually refined via a positive feedback loop to provide improved suggestions of similar past incidents. For example, a plurality of user feedback data objects, such as clicks, dwells, and/or explicit feedback, may be used to retrain at least one of a natural language processing machine learning model, an incident categorization machine learning model, or a candidate ranking machine learning model. These characteristics as well as additional features, functions, and details are described below. Similarly, corresponding and additional embodiments are also described below.

### Example Systems and Apparatuses of the Disclosure

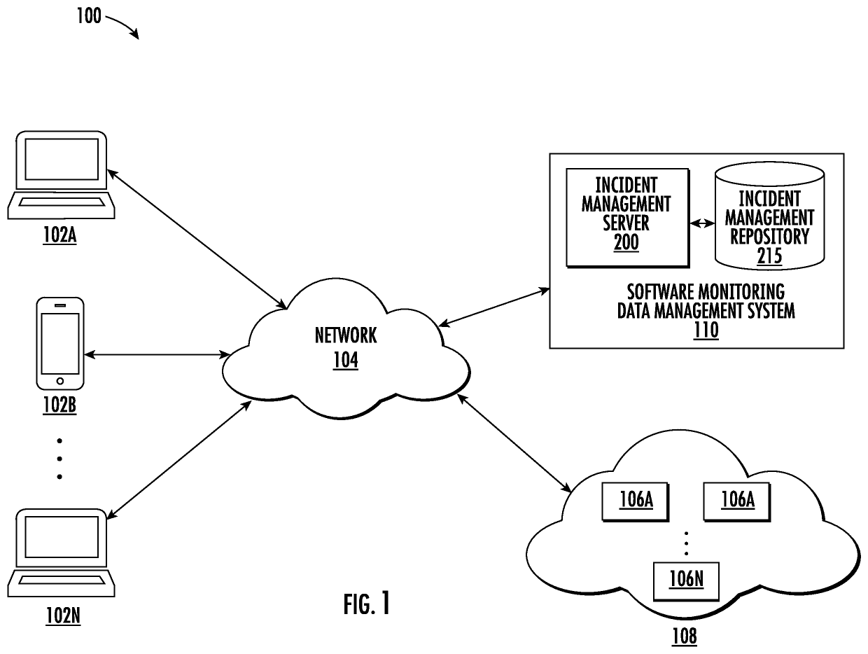

Referring now to FIG. 1, an example enterprise software platform 100 within which some embodiments of the present disclosure operate is illustrated. The example enterprise software platform 100 comprises one or more computing environment(s) 108, a software monitoring data management system 110, and a plurality of client devices 102A-102N, each communicatively connected through a communications network 104. The computing environment 108 includes any number of computing system services, of which one or more computing system service(s) depend on one or more other computing system service(s) of the computing environment 108. For example, as illustrated, the computing environment 108 includes at least computing system services 106A-106N.

Each computing system service 106A-106N includes one or more computing device(s) embodied in hardware, software, firmware, and/or any combination thereof. In some embodiments, a computing system service 106A-106N includes a server, end-user computing terminal, processing device (e.g., a central processing unit or “CPU”), or other hardware that is specially configured via firmware and/or software executed thereupon to perform particular process(es). The process(es) configure the computing hardware to provide particular functionality defined by the process(es). In some embodiments, one or more computing system services 106A-106N utilize shared computing hardware, for example a single server, shared processor, shared database, and/or the like. While various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

In some embodiments, a computing system service 106A-106N is embodied virtually, for example in a virtual environment, virtual machine, and/or the like. In this regard, it will be appreciated that the computing system service 106A-106N may be embodied entirely in software. Additionally or alternatively, in some embodiments, a computing system service 106A-106N is embodied by a cloud system, a partially cloud system (e.g., a cloud server communicating with one or more server(s) locally controlled by a particular entity responsible for providing a particular portion of functionality), and/or the like.

The computing environment 108 includes any number of interconnected computing system services 106A-106N that, alone and/or in conjunction with one another, provide particular functionality to one or more end user(s) and/or intermediary systems (e.g., other computing system services). In some embodiments, the computing environment 108 embodies a computing architecture supporting a particular software application, where computing system service 106A-106N each embody microservices (or an application which may include any number of sub-services) that provide particular functionality. In some embodiments, each computing system service 106A-106N embodies a microservice that fulfills a particular portion of functionality, with each of the microservices functioning cooperatively to provide the complete functionality of a particular service and/or application. A particular end-user application may be dependent on any number of computing system services 106A-106N that enable the end-user application to provide particular functionality to the user, with each of those computing system services 106A-106N being further dependent on any number of other computing system services 106A-106N.

With continued reference to FIG. 1, in some embodiments, the software monitoring data management system 110 may include one or more computing device(s) embodied in hardware, software, firmware, and/or combinations thereof. For example, in some embodiments, the software monitoring data management system 110 includes at least one server, such as incident management server 200, the server specially configured via hardware, software, firmware, and/or a combination thereof, to provide functionality for, inter alia, generating a past incident insight interface component comprising a listing of a past incident candidate data object suggestion set, outputting the past incident insight interface component for rendering to an incident alert management user interface, identifying an incident category of the current incident data object, ranking past incident data objects, transmitting notification(s) to team members, etc. Additionally or alternatively, in some embodiments, the software monitoring data management system 110 includes at least one end user computing terminal, backend system, and/or the like.

In some embodiments, additionally or alternatively, the software monitoring data management system 110 includes at least one data repository, such as incident management repository 215. The incident management repository 215 includes at least one computing device embodied in hardware, software, firmware, and/or any combination thereof, that temporarily and/or permanently stores data generated, received, and/or otherwise utilized by the software monitoring data management system 110 and/or the incident management server 200. In some embodiments, the incident management repository 215 is embodied by a database embodied in hardware (e.g., an encrypted and/or physically secured drive) configured with particular firmware, entirely in software (e.g., a virtual database, DBMS, and/or the like), a cloud database, and/or the like. Such repository(ies) may be hosted by the incident management server 200 or otherwise hosted by devices in communication with the incident management server 200.

In some embodiments, the incident management repository 215 embodies a non-transitory computer memory, which is configured to read and/or write data such as incident data objects (e.g., past and/or current/ongoing), incident attribute(s), incident identifier(s), incident title(s), incident description(s), faulty service identifier(s), affected product identifier(s), PIRs, RCAs, team member identifier(s), team member data object(s), creation date(s), visual emphasis element(s), priority(ies), past incident candidate data object set(s), past incident candidate data object subset(s), past incident candidate data object suggestion set(s), user feedback data object(s), incident categories, similarity score(s), recency score(s), relevance score(s), updated relevance score(s), ranking(s), predetermined threshold(s), and/or the like. In some embodiments, the incident management repository 215 may be utilized to train and/or continually refine any of the machine learning models described herein. The incident management repository 215 may include past incident alerts (e.g., historical alerts and/or alerts received during recent operation). Incident data objects stored in the incident management repository 215 may require transformation and/or conversion before use in the software monitoring data management system 110.

In some embodiments, a data repository (e.g., incident management repository 215) of the software monitoring data management system 110, is accessible to a server (e.g., incident management server 200) of the software monitoring data management system 110 to enable the server to store data to the data repository, retrieve data from the data repository, and/or otherwise manage data within the data repository. In some embodiments, for example, the software monitoring data management system 110 utilizes the incident management repository 215 to store and/or retrieve data such as incident data objects (e.g., past and/or current/ongoing), incident attribute(s), incident identifier(s), incident title(s), incident description(s), faulty service identifier(s), affected product identifier(s), PIRs, RCAs, team member identifier(s), team member data object(s), creation date(s), visual emphasis element(s), priority(ies), past incident candidate data object set(s), past incident candidate data object subset(s), past incident candidate data object suggestion set(s), user feedback data object(s), incident categories, similarity score(s), recency score(s), relevance score(s), updated relevance score(s), ranking(s), predetermined threshold(s), and/or the like.

In some embodiments, the software monitoring data management system 110 communicates with one or more computing system service(s) 106A-106N of the computing environment 108 over the communications network 104. The communications network 104 may embody any of a myriad of network configurations. In some embodiments, the communications network 104 embodies a public network (e.g., the Internet) in whole or in part. In some embodiments, the communications network 104 embodies a private network (e.g., an internal network between particular computing devices) in whole or in part. In some other embodiments, the communications network 104 embodies a hybrid network (e.g., a network enabling internal communications between particular connected computing devices and external communications with other computing devices). The communications network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the communications network 104 (e.g., network routers, etc.). For example, the communications network 104 may include one or more base station(s), relay(s), router(s), switch(es), cell tower(s), communications cable(s) and/or associated routing station(s), and/or the like. In some embodiments, the communications network 104 includes one or more user entity-controlled computing device(s) and/or other enterprise device(s) (e.g., an end-user's or enterprise router, modem, switch, and/or other network access point) and/or one or more external utility devices (e.g., Internet service provider communication tower(s) and/or other device(s)). The communications network 104 may include a cellular telephone, an 802.11, 802.16, 802.20, and/or WiMAX network. Further, the communications network 104 may utilize a variety of networking protocols now available or later developed including, but not limited to Transmission Control Protocol/Internet Protocol (TCP/IP) based networking protocols. In some embodiments, the protocol is a custom protocol of JavaScript Object Notation (JSON) objects sent via a WebSocket channel. In some embodiments, the protocol is JSON over RPC, JSON over REST/HTTP, the like, or combinations thereof.

In some embodiments, the software monitoring data management system 110 and the computing system services 106A-106N of the computing environment 108 communicate over the communications network 104 to transmit and/or receive data used to identify dependencies between computing system services, receive an incident data object at the software monitoring data management system 110 of an incident or data event affecting a computing system service 106A-106N of the computing environment 108, and/or the like.

It will be appreciated that, in some embodiments, the software monitoring data management system 110 is communicable with a plurality of computing environments, such as computing environment 108. In some embodiments, the software monitoring data management system 110 is communicable with a plurality of computing environments 108 utilizing the same communications network 104, for example over the Internet, in whole or in part (e.g., in some embodiments having at least a portion of intermediary computing devices specific to the computing environment). In some other embodiments, the software monitoring data management system 110 is communicable with a plurality of computing environments 108 utilizing a dedicated and/or private network for each computing environment 108.

It will be appreciated that, in some embodiments, the software monitoring data management system 110 is local to and/or embodied as a subsystem within the computing environment 108 to be processed. For example, in some embodiments, the software monitoring data management system 110 may be positioned locally within the computing environment 108 to be processed by the software monitoring data management system 110. In some such embodiments, the software monitoring data management system 110 performs incident management and/or past incident insight interface component-related functionality associated only with the computing system services 106A-106N of the computing environment 108. In this regard, the software monitoring data management system 110, in some such embodiments, represents a dedicated system for performing such functionality associated with the computing environment 108. Additionally, in some embodiments, the software monitoring data management system 110 is controlled by the same entity that controls some or all of the computing system services 106A-106N of the computing environment 108. In still other embodiments, the entity that controls the software monitoring data management system 110 may differ from the entity that controls some or all of the computing system services 106A-106N of the computing environment 108. It should be appreciated that, in some embodiments, the software monitoring data management system 110 communicates directly with one or more computing system services 106A-106N in the computing environment 108.

As further depicted in FIG. 1, the example enterprise software platform 100 includes a plurality of client devices 102A-102N. An example client device 102A-102N may include a mobile device, a smart phone, a tablet computer, a laptop computer, a wearable device, a personal computer, an enterprise computer, a virtual reality device, or another type of computing device. In one or more embodiments, a client device 102A-102N may be authorized to interface with other computing devices (e.g., software monitoring data management system 110, incident management server 200, computing environment 108, and/or computing system services 106A-106N) on the enterprise software platform 100 to view, modify, upload, download, and/or otherwise interact with files, libraries, and/or other objects. In one or more embodiments, a client device 102A-102N may further access incident data objects stored in the incident management repository 215.

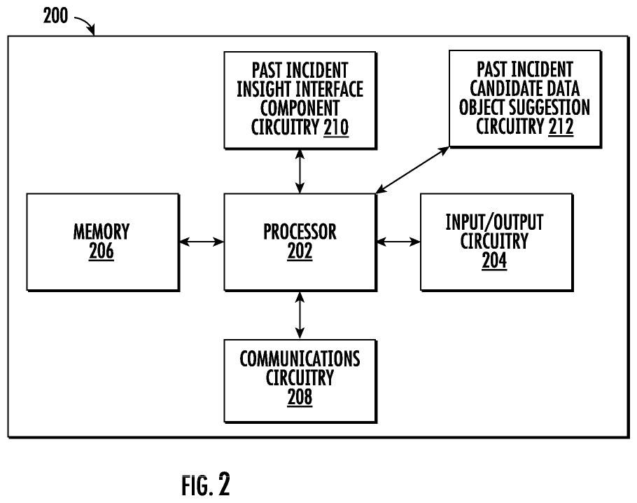

FIG. 2 illustrates an example incident management server 200 in accordance with at least some example embodiments of the present disclosure. In some embodiments, a software monitoring data management system, such as the software monitoring data management system 110, is embodied by one or more computing devices, such as the incident management server 200 as depicted and described in FIG. 2. In accordance with some example embodiments, incident management server 200 may include various components, modules, circuitries, or means, such as processor 202, input/output circuitry 204, memory 206, communications circuitry 208, past incident insight interface component circuitry 210, and/or past incident candidate data object suggestion circuitry 212. In some embodiments, incident management server 200 may be configured, using one or more of the sets of circuitry embodying processor 202, input/output circuitry 204, memory 206, communications circuitry 208, past incident insight interface component circuitry 210, and/or past incident candidate data object suggestion circuitry 212 to execute and perform the operations described herein. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although components are described with respect to functional limitations, it should be understood that the particular implementations necessarily include the use of particular computing hardware. It should also be understood that, in some embodiments, certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the incident management server 200 provide or supplement the functionality of other particular sets of circuitry. For example, the processor 202 in some embodiments provides processing functionality to any one or more of the sets of circuitry, the memory 206 provides storage functionality to any one or more of the sets of circuitry, the communications circuitry 208 provides network interface functionality to any one or more of the sets of circuitry, and/or the like.

In some embodiments, the processor 202 (and/or co-processor or any other processing circuitry assisting or otherwise associated with the processor) is/are in communication with the memory 206 via a bus for passing information among components of incident management server 200. In some embodiments, for example, the memory 206 is non-transitory and may include, for example, one or more volatile and/or non-volatile memories, or some combination thereof. In other words, for example, the memory 206 in some embodiments includes or embodies an electronic storage device (e.g., a non-transitory computer readable storage medium). In some embodiments, the memory 206 is configured to store information, data, content, applications, instructions, or the like, for enabling the incident management server 200 to carry out various functions in accordance with example embodiments of the present disclosure.

The processor 202 may be embodied in a number of different ways. For example, in some example embodiments, the processor 202 includes one or more processing devices configured to perform independently. Additionally, or alternatively, in some embodiments, the processor 202 includes one or more processor(s) configured in tandem via a bus to enable independent execution of instructions, pipelining, and/or multithreading. The processor 202 may, for example, be embodied as various means including one or more microprocessors with accompanying digital signal processor(s), one or more processor(s) without an accompanying digital signal processor, one or more co-processors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the terms “processor” or “processing circuitry” should be understood to include a single core processor, a multi-core processor, multiple processors internal to the incident management server 200, and/or one or more remote or “cloud” processor(s) external to incident management server 200. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as incident management server 200. The plurality of processors may be in operative communication with each other and may be collectively configured to perform one or more functionalities of the incident management server 200 as described herein.

In an example embodiment, the processor 202 is configured to execute instructions stored in the memory 206 or otherwise accessible to the processor 202. Alternatively, or additionally, the processor 202, in some embodiments, is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively, or additionally, as another example, in some example embodiments when the processor 202 is embodied as an executor of software instructions, the instructions specifically configure the processor 202 to perform one or more algorithms embodied in the specific operations described herein when such instructions are executed. For example, these instructions, when executed by processor 202, may cause incident management server 200 to perform one or more of the functionalities of the incident management server 200 as described herein.

In some embodiments, the incident management server 200 includes input/output circuitry 204 that provides an audible, visual, mechanical, or other output to the user and/or, in some embodiments, to receive an indication of an input from a user, a client device 102A-102N, or another source. In some embodiments, the input/output circuitry 204 is in communication with the processor 202 to provide such functionality. The input/output circuitry 204 may include means for performing analog-to-digital and/or digital-to-analog data conversions. The input/output circuitry 204 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. The input/output circuitry 204 may comprise one or more user interface(s) and, in some embodiments, includes a display that comprises the interface(s) rendered as a web user interface, an application user interface, a user device, a backend system, or the like. The processor 202 and/or input/output circuitry 204 comprising the processor 202 may be configured to control one or more functions of a display or one or more user interface elements through computer program instructions (e.g., software and/or firmware) stored on a memory accessible to the processor 202 (e.g., memory 206, and/or the like). In some embodiments, the input/output circuitry 204 includes or utilizes a user-facing application to provide input/output functionality to a client device, such as a service maintainer device, and/or other display associated with a user. In some embodiments, aspects of input/output circuitry 204 may be reduced as compared to embodiments where incident management server 200 may be implemented as an end-user machine or other type of device designed for complex user interactions. In some embodiments (like other components discussed herein), input/output circuitry 204 may even be eliminated from incident management server 200. Input/output circuitry 204 may be in communication, such as via a bus, with memory 206, communications circuitry 208, and/or any other component. Although more than one input/output circuitry 204 and/or other component can be included in incident management server 200, only one is shown in FIG. 2 to avoid overcomplicating the disclosure (e.g., like the other components discussed herein).

In some embodiments, the incident management server 200 includes communications circuitry 208. The communications circuitry 208 includes any means, such as a device or circuitry embodied in either hardware, software, firmware or a combination of hardware, software, and/or firmware, that is configured to receive and/or transmit data from/to a network and/or any other device, circuitry, or module in communication with the incident management server 200. In this regard, the communications circuitry 208 includes, for example, in some embodiments, a network interface for enabling communications with a wired or wireless communications network. For example, in some embodiments, communications circuitry 208 is configured to receive and/or transmit any data that may be stored by memory 206 using any protocol that may be used for communications between computing devices.

Additionally, or alternatively, in some embodiments, the communications circuitry 208 includes one or more network interface card(s), antenna (e), transmitter(s), receiver(s), bus(es), switch(es), router(s), modem(s), and supporting hardware, firmware, and/or software, or any other device suitable for enabling communications via one or more communications network(s) (e.g., communications network 104). Additionally, or alternatively, the communications circuitry 208 includes circuitry for interacting with the antenna (e) and/or other hardware or software to cause transmission of signals via the antenna (e) or to handle receipt of signals received via the antenna (e). These signals may be transmitted by incident management server 200 using any of a number of wireless personal area network (PAN) technologies, such as Bluetooth® v1.0 through v3.0, Bluetooth® Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Communications circuitry 208 may, additionally or alternatively, be in communication, such as via a bus, with the memory 206, input/output circuitry 204, and/or any other component of incident management server 200. In some embodiments, the communications circuitry 208 enables transmission to and/or receipt of data from a client device (e.g., client device 102A-102N) in communication with the incident management server 200.

In some embodiments, the past incident insight interface component circuitry 210 may also or instead be included and configured to perform the functionality discussed herein related to managing past incident insight interface components. The past incident insight interface component circuitry 210 includes hardware, software, firmware, and/or a combination thereof, that supports various functionality associated with interfacing with, for example, client devices 102A-102N, the interface management repository 215, computing system services 106A-106N, and/or the computing environment 108. For example, in some embodiments, the past incident insight interface component circuitry 210 may include hardware, software, firmware, and/or a combination thereof, to detect and/or receive past incident insight interface component request and/or incident data objects and transmit necessary response data. In some embodiments, the past incident insight interface component circuitry 210 may include hardware, software, firmware, and/or a combination thereof, to configure the generation, output, and/or update of past incident insight interface components.

It should be appreciated that in some embodiments, the past incident insight interface component circuitry 210 performs one or more of such exemplary actions in combination with another set of circuitry of the incident management server 200, such as one or more of processor 202, input/output circuitry 204, memory 206, and/or communications circuitry 208. For example, in some embodiments, past incident insight interface component circuitry 210 utilizes processing circuitry, such as the processor 202 and/or the like, to perform one or more of its corresponding operations. In some instances, past incident insight interface component circuitry 210 may generate an initial interface that is subsequently modified by user feedback data objects, updated rankings and/or relevance scores of past incident data objects, requests for second or detailed levels of information associated with selected past incident data objects, and/or the like. In a further example, in some embodiments, some or all of the functionality of past incident insight interface component circuitry 210 may be performed by processor 202. In this regard, some or all of the example processes and algorithms discussed herein can be performed by at least one processor 202 and/or past incident insight interface component circuitry 210. It should also be appreciated that, in some embodiments, past incident insight interface component circuitry 210 includes a separate processor, specially configured field programmable gate array (FPGA), or application specific interface circuit (ASIC) to perform its corresponding functions.

Additionally or alternatively, in some embodiments, past incident insight interface component circuitry 210 utilizes memory 206 to store collected information. For example, in some implementations, past incident insight interface component circuitry 210 includes hardware, software, firmware, and/or a combination thereof, that interacts with memory 206 to send, retrieve, update, and/or store data values embodied by and/or associated with incident data objects (e.g., past and/or current), incident attribute(s), incident identifier(s), incident title(s), incident description(s), faulty service identifier(s), affected product identifier(s), PIRs, RCAs, team member identifier(s), team member data object(s), creation date(s), visual emphasis element(s), priority(ies), past incident candidate data object set(s), past incident candidate data object subset(s), past incident candidate data object suggestion set(s), user feedback data object(s), incident categories, similarity score(s), recency score(s), relevance score(s), updated relevance score(s), ranking(s), predetermined threshold(s), and associated data that is configured to support the operations of the past incident insight interface component circuitry 210 and the remaining circuitry. Additionally or alternatively, in some embodiments, past incident insight interface component circuitry 210 utilizes input/output circuitry 204 to facilitate user output (e.g., causing rendering and/or updating of one or more user interface(s) or interface component(s) such as past incident insight interface component or incident alert management user interface), and/or to receive user input (e.g., user clicks, user taps, keyboard interactions, user gesture, and/or the like). Additionally or alternatively still, in some embodiments, past incident insight interface component circuitry 210 utilizes communications circuitry 208 to initiate transmissions to another computing device, receive transmissions from another computing device, communicate signals between the various sets of circuitry as depicted, and/or the like.

The past incident candidate data object suggestion circuitry 212 includes hardware, software, firmware, and/or a combination thereof, that supports various functionality associated with determining potentially similar past incident data objects to a current incident data object. For example, past incident candidate data object suggestion circuitry 212 may, inter alia, identify a past incident candidate data object set, determine a primary ranking of a past incident candidate data object set or a subset thereof, determine one or more subsequent rankings of primarily ranked past incident candidate data objects, and/or determine a past incident candidate data object suggestion set. In some embodiments, the past incident candidate data object suggestion circuitry 212 may also or instead be included and configured to perform the functionality of receiving user feedback data objects, causing storage the one or more user feedback data objects in a database, continually refining machine learning models (e.g., based on a positive feedback loop using the user feedback data objects). In some embodiments, the past incident candidate data object suggestion circuitry 212 may also or instead be included and configured to perform the functionality of identifying past incident candidate data object sets, filtering past incident data objects, culling past incident data objects, extracting incident attributes, performing primary ranking of past incident data objects, performing subsequent ranking(s) of past incident data objects, etc. In still further embodiments, the past incident candidate data object suggestion circuitry 212 may also or instead be included and configured to perform the functionality of determining similarity scores, recency scores, relevance scores, and/or updated relevance scores.

Additionally, or alternatively, in some embodiments, one or more of the sets of circuitry 202-212 are combinable. Additionally, or alternatively, in some embodiments, one or more of the sets of circuitry perform some or all of the functionality described associated with another component. For example, in some embodiments, one or more sets of circuitry 202-212 are combined into a single module embodied in hardware, software, firmware, and/or a combination thereof. Similarly, in some embodiments, one or more of the sets of circuitry, for example, past incident insight interface component circuitry 210 and/or past incident candidate data object suggestion circuitry 212, is/are combined such that the processor 202 performs one or more of the operations described above with respect to each of these circuitry individually.

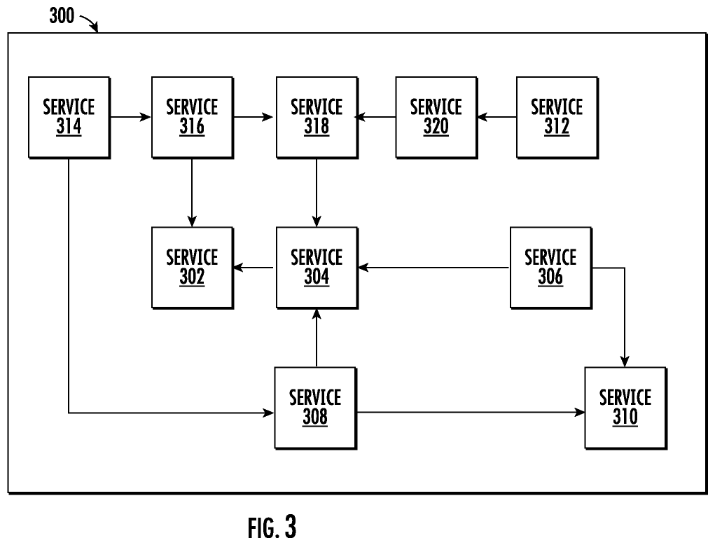

FIG. 3 illustrates a system diagram representing a snapshot of sample dependencies between computing system services of an interdependent computing environment in accordance with at least some embodiments of the present disclosure. Specifically, FIG. 3 depicts a computing environment 300 including a plurality of computing system services, with various computing system services in the plurality of computing system services dependent on one or more other computing system service in the computing environment 300. The plurality of computing system services includes computing system service 302 through computing system service 320. It will be appreciated that a computing system service may be dependent on another computing system service for any of a myriad of reasons. In some embodiments, a first computing system service is dependent on a second computing system service when the first computing system service accesses functionality of the second computing system service to complete functionality to be performed by the first computing system service. In some embodiments, a dependency is defined based at least in part on remote procedural call(s), application programming interface call(s), and/or other transmission(s) from a first computing system service to a second computing system service, where the result(s) of such RPC(s), API call(s), and/or transmission(s) are utilized by the first computing system service to complete one or more process(es) for providing particular functionality. Alternatively or additionally, in some embodiments, a dependency is defined at a computing system service level based at least in part on imported libraries, external program(s), and/or other link(s) between a first computing system service and a second computing system service that enables the first computing system service to access particular functionality of the second computing system service. It will be appreciated that any number of computing system service dependencies may exist between the various computing system services therein and such service dependencies may be ever-changing.

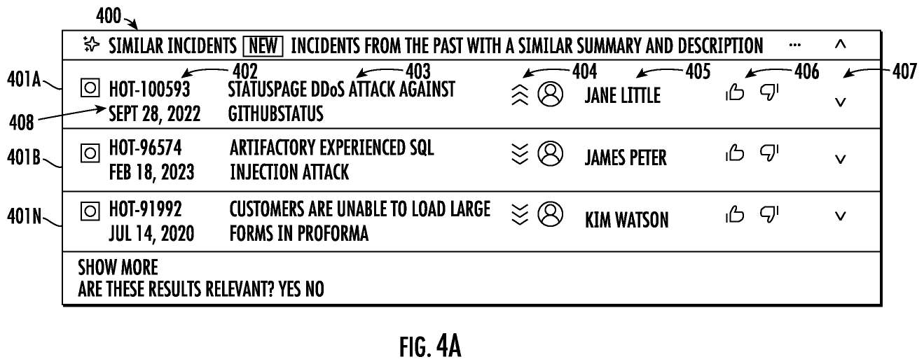

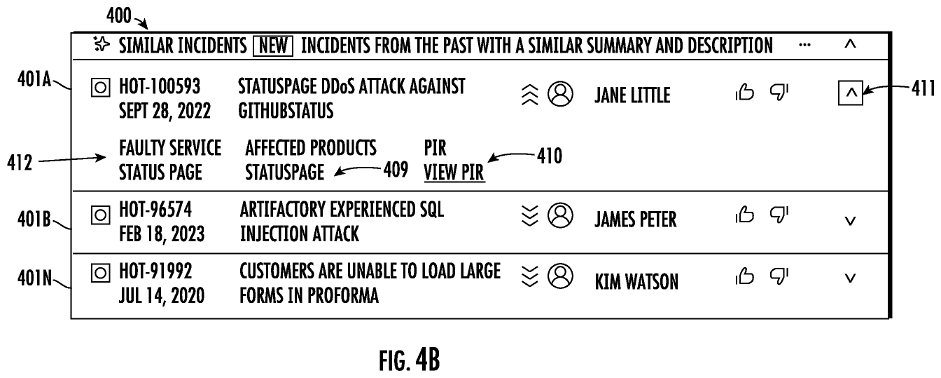

In various embodiments of the present disclosure, an apparatus (e.g., incident management server 200 or client device 102A) is configured to output a past incident insight interface component for rendering to an incident alert management user interface in a software monitoring data management system 110. Referring now to FIGS. 4A and 4B, example past incident insight interface components structured in accordance with various embodiments of the subject disclosure are illustrated. In a non-limiting example, the depicted past incident insight interface component 400 is configured to display a past incident candidate data object suggestion set, the past incident candidate data object suggestion set listing one or more of the subsequently ranked past incident candidate data objects 401A-401N as described herein.

In some embodiments, the past incident insight interface component 400 may expose a first or summary level of information for each of the subsequently ranked past incident candidate data objects 401A-401N displayed to the past incident insight interface component 400. For example, in the non-limiting example depicted in FIG. 4A, the example past incident insight interface component 400 depicts exposure of a first or summary level of information for each of the first three subsequently ranked past incident candidate data objects 401A-401N of the past incident candidate data object suggestion set. Although three subsequently ranked past incident candidate data objects 401A-401N of the past incident candidate data object suggestion set are depicted in FIG. 4A, any number of displayed past incident candidate data objects 401A-401N are contemplated by this disclosure as will be apparent to one of ordinary skill in the art. Indeed, the example past incident insight interface component 400 depicted in FIG. 4A comprises a “Show More” actuator button for displaying additional subsequently ranked past incident candidate data objects 401N of the past incident candidate data object suggestion set.

The first or summary level of information of a past incident data object may include one or more of an incident title 403 (e.g., “Statuspage DDOS Attack Against GithubStatus”), a creation date 408 associated with the incident (“Sep. 28, 2022”), an incident identifier 402 (e.g., “HOT-100593”), or a visual emphasis element 404 associated with a priority of the incident (e.g., series of up arrows, series of down arrows, etc.). For example, in the first past incident data object depicted in FIG. 4A, a visual emphasis element 404 (e.g., a series of up arrows) visually conveys the priority (e.g., high) of the associated past incident data object 401A and in the second past incident data object 401B depicted in FIG. 4A, and a visual emphasis element (e.g., a series of down arrows) visually conveys the priority (e.g., low) in the third past incident data object 401N. The visual emphasis element 404 may be any icon, text, and/or background displayed in the past incident data object 401 to visually indicate the associated priority. In some embodiments, the visual emphasis element 404 additionally or alternatively employs a contextually relevant coloring scheme to visually indicate the priority. For example, in some embodiments, the series of up arrows is rendered in orange and/or red to indicate the perceived high priority. In some embodiments, a series of down arrows is rendered in blue and/or gray to indicate the perceived low priority. Additional examples of visual emphasis elements 404 include emphasizing (e.g., coloring scheme, highlighted, bolded, italicized, enlarged, shaded, flashing, pulsing, or changing in size, etc.) or de-emphasizing an icon or text displayed in association with a past incident data object 401 as part of the past incident insight interface component 400. Such examples are for purposes of illustration and not of limitation and other suitable variations of visual indicators for visually conveying priority are also contemplated by this disclosure as will be apparent to one of ordinary skill in the art.

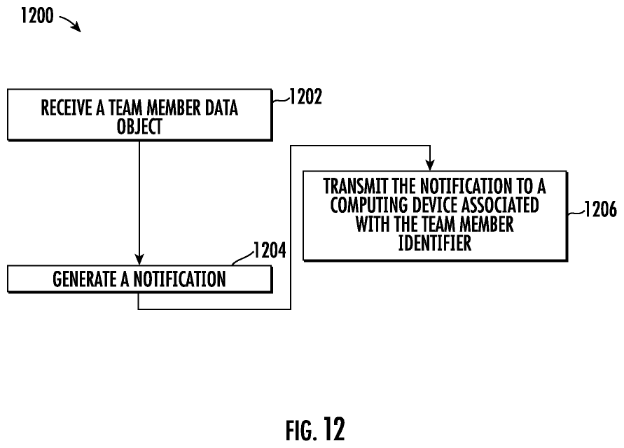

In some embodiments, the first or summary level of information may include a team member identifier 405 (e.g., the avatar image and/or “Jane Little”) associated with, assigned to, and/or responsible for the past incident. As further described in relation to FIG. 12, in some further embodiments, the incident management server 200 may be configured to generate and transmit a notification to an associated team member in response to detecting and/or receiving indication of end-user interaction with the team member identifier 405 (e.g., the avatar image and/or “Jane Little”) of a selected subsequently ranked past incident candidate data object 401.

In some embodiments, the past incident insight interface component 400 exposing the first or summary level of information for each subsequently ranked past incident candidate data object may also comprise and/or further depict one or more feedback actuator buttons 406 (e.g., thumbs up depiction, thumbs down depiction, etc.) in association with each past incident candidate data object 401 or any other component(s) for enabling end-user interactions with the client computing device in relation to providing feedback regarding, for example, the inclusion and/or ranking of a past incident candidate data object in the past incident candidate data object suggestion set. In some embodiments, end-user interactions may remove a past incident candidate data object, decrease a ranking of a past incident candidate data object, and/or increase a ranking of past incident data object. Additionally or alternatively, in some embodiments, the past incident insight interface component 400 may comprise and/or depict a user feedback interaction option configured to enable the user to generally indicate whether or not the past incident candidate data objects are relevant (e.g., “Are these results relevant? Yes No”). In some further embodiments, the incident management server 200 may cause an action, such as re-ranking one or more past incident candidate data objects (e.g., all past incident candidate data objects of the past incident candidate data object set, past incident candidate data object subset, and/or the past incident candidate data object suggestion set) in response to user interaction with such a user feedback interaction option.

In some embodiments, the past incident insight interface component 400 may expose a second or detailed level of information for a selected subsequently ranked past incident candidate data object 401 displayed to the past incident insight interface component 400. For example, in the non-limiting example depicted in FIG. 4A, the past incident insight interface component 400 may comprise an expansion actuator button 407 (e.g., a down carrot symbol) with each of the subsequently ranked past incident candidate data objects 401A-401N rendered to the of the past incident candidate data object suggestion set and end-user interaction with such expansion actuator button 407 may indicate that the end-user wants to view additional information related to the selected subsequently ranked past incident candidate data object 401. In some embodiments, in response to detecting and/or receiving indication of end-user interaction with the expansion actuator button 407 of a selected subsequently ranked past incident candidate data object 401, the incident management server 200 is configured to cause rendering of a second or detailed level of information for the selected subsequently ranked past incident candidate data object 401, as depicted in FIG. 4B. In addition to or in alternative to the information exposed in the first or summary level of information of a past incident data object 401, the second or detailed level of information may include, for example, one or more of a faulty service identifier 412 (e.g., “status-page”), an affected product identifier 409 (“StatusPage”), or a link 410 to a post incident report (PIR), if available (“View PIR”). In some embodiments, as depicted in the non-limiting example in FIG. 4B, the past incident insight interface component 400 may comprise a contraction actuator button 411 (e.g., an up carrot symbol) in association with the second or detailed level of information exposed of a past incident data object 401, wherein end-user interaction with such contraction actuator button 411 may indicate that end-user wants to view only the first or summary level of information related to the selected subsequently ranked past incident candidate data object 401.

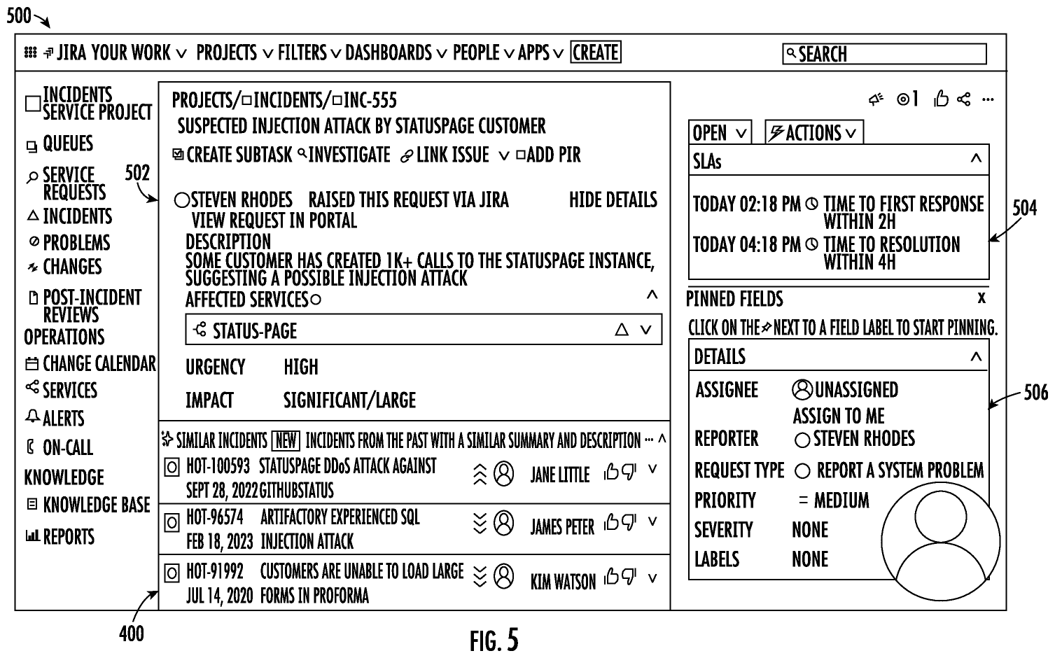

Referring now to FIG. 5, an example incident alert management user interface 500 structured in accordance with various embodiments of the subject disclosure is illustrated. The example incident alert management user interface 500 comprises a past incident insight interface component 400, as previously described in relation to FIGS. 4A and 4B. Although the past incident insight interface component 400 is depicted as being arranged or rendered in a main pane of the incident alert management user interface 500, such depiction is for purposes of illustration and not of limitation and other suitable variations (e.g., sidebar pane, etc.) of arranging or rendering interface components, panes, and panels described herein to the incident alert management user interface 500 are also contemplated by this disclosure as will be apparent to one of ordinary skill in the art. Moreover, the past incident insight interface component 400 is depicted in association with a current incident data object view of the incident alert management user interface 500, however, other views are contemplated.

In a non-limiting example, the depicted current incident data object view of the incident alert management user interface 500 may comprise a current incident data object interface component 502 which may be configured to display information associated with a current incident data object, including, for example, an incident identifier (e.g., “INC-555”), an incident title (“Suspected injection attack by Statuspage customer”), an incident description (“Some customer has created 1k+ calls to the Statuspage instance, suggesting a possible injection attack”), an urgency level (“Urgency High”), an impact level (“Impact Significant/Large”), a faulty service identifier (“Status-page”), or a user identifier associated with a creation of the current incident data object (“Steven Rhodes raised this request via Jira”). In some embodiments, the incident alert management user interface 500 may comprise an SLA interface component 504 exposing SLA information associated with the current incident data object (e.g., “Time to first response within 2 h”, “Time to resolution within 4 h”, etc.). In some embodiments, the incident alert management user interface 500 comprises a details interface component 506 which may be configured to display detailed information associated with a current incident data object, including, for example, an assignee user identifier, a user identifier associated with a reporting of the current incident data object, (“Reporter Steven Roads”), a request type identifier, a priority level (“Priority Medium”), a severity level, or a label identifier.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to output a past incident insight interface component in a software monitoring data management system in a number of ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

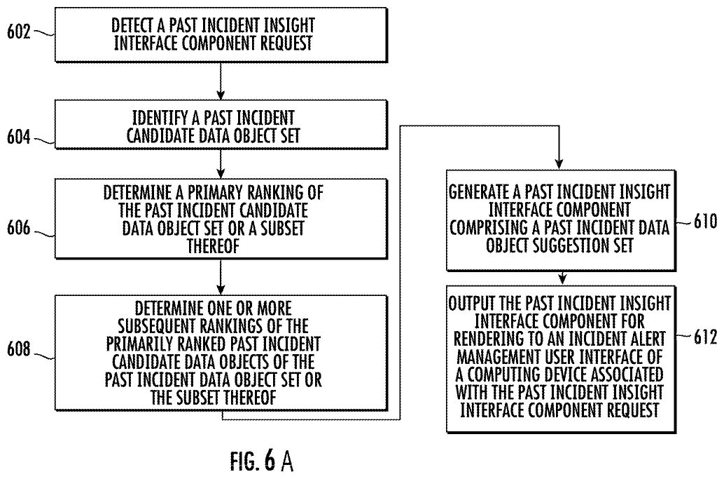

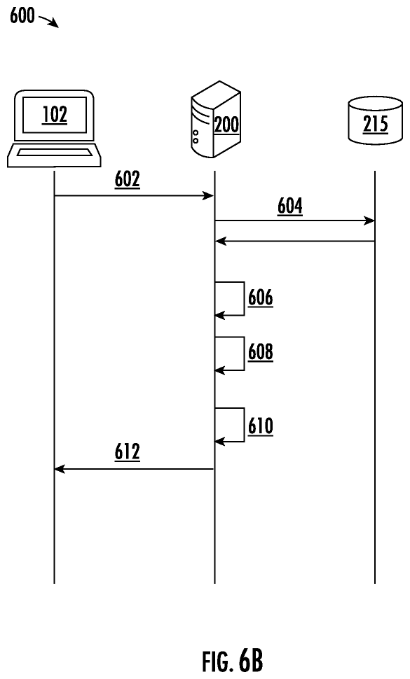

FIG. 6A is a flowchart broadly illustrating a series of operations or process blocks that are executed or performed to output a past incident insight interface component in a software monitoring data management system in accordance with some example embodiments of the present disclosure. In some embodiments, the process 600 is embodied by computer program code stored on a non-transitory computer-readable storage medium of a computer program product configured for execution to perform the process as depicted and described. In this regard, in some such embodiments, the incident management server 200 is specially configured by computer-coded instructions (e.g., computer program instructions) stored thereon, for example in the memory 206 and/or another component depicted and/or described herein and/or otherwise accessible to the incident management server 200, for performing the operations as depicted and described. Alternatively or additionally, in some embodiments, the process 600 is performed by one or more specially configured computing devices, such as the incident management server 200 alone or in communication with one or more other component(s), device(s), system(s), and/or the like. For example, in some embodiments, the incident management server 200 is in communication with one or more external apparatus(es), system(s), device(s), and/or the like, to perform one or more of the operations as depicted and described. For purposes of simplifying the description, the process 600 is described as performed by and from the perspective of the incident management server 200. In this regard, performance of the operations may invoke one or more of processor 202, input/output circuitry 204, memory 206, communications circuitry 208, past incident insight interface component circuitry 210, and/or past incident candidate data object suggestion circuitry 212. A signal diagram illustrating the example process 600 is provided at FIG. 6B.

In the embodiment illustrated in FIG. 6A, the flowchart illustrates process 600 which begins at Block 602. At Block 602, the incident management server 200 includes means, such as the processor 202, input/output circuitry 204, memory 206, communications circuitry 208, past incident insight interface component circuitry 210, past incident candidate data object suggestion circuitry 212, or a combination thereof, to detect a past incident insight interface component request in response to user interaction with a software monitoring data management system. The incident management server 200 may detect the past incident insight interface component request in any of a myriad of manners. For example, in some embodiments, the past incident insight interface component request may be detected in response to user interaction with and/or transmitted to the software monitoring data management system in association with viewing a current incident data object. That is, in some embodiments, the incident management server 200 receives an incident alert management user interface request from a client device (e.g., a client device associated with incident manager), indicating a request to cause display of information associated with a current incident data object. In some such embodiments, the past incident insight interface component request is received as a transmission associated with or as part of the transmission of the incident alert management user interface request. As described herein, the past incident insight interface component request may be associated with the current incident data object, wherein the current incident data object may comprise text, for example, an incident title, an incident description, or the like.

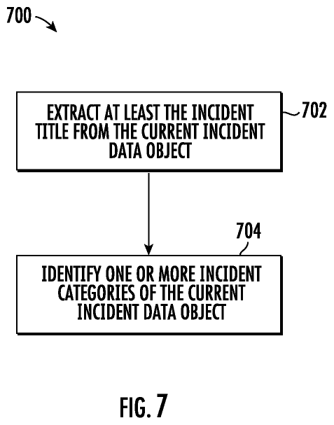

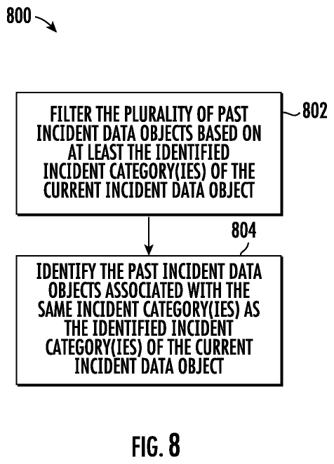

At Block 604, the incident management server 200 includes means, such as the processor 202, input/output circuitry 204, memory 206, communications circuitry 208, past incident insight interface component circuitry 210, past incident candidate data object suggestion circuitry 212, or a combination thereof, to identify a past incident candidate data object set. As further described in relation to FIG. 7, the incident management server 200 utilizes one or more incident attributes of the current incident data object (e.g., incident title, incident description, etc.) to categorize the current incident data object, and as further described in relation to FIG. 8, the incident management server 200 culls and filters a plurality of past incident candidate objects based on at least such identified incident category(ies) in order to identify the past incident candidate data object set.

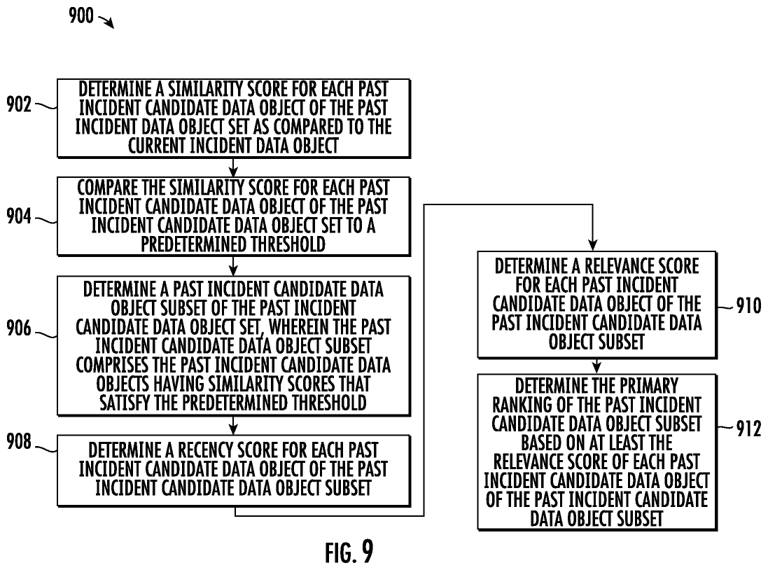

At Block 606, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine a primary ranking of the past incident candidate data object set or a subset thereof. For example, as further described in relation to FIG. 9, in some embodiments, the primary ranking is performed based on a respective initial relevance score of each past incident candidate data object in the past incident candidate data object set or a subset thereof.

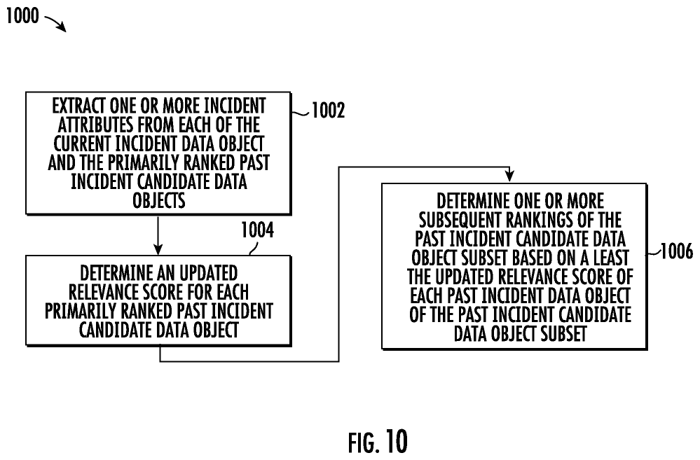

At Block 608, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine one or more subsequent rankings of the primarily ranked past incident candidate data objects of the past incident candidate data object set or subset thereof. As further described in relation to FIG. 10, in some embodiments, the one or more subsequent rankings may be performed based on a respective updated relevance score of each primarily ranked past incident candidate data object. For example, the incident management server 200 may use one or more incident attributes (e.g., a faulty service identifier, a service dependency of the faulty service identifier (e.g., team member), an incident description, an incident priority level, a presence or an absence of a post incident report (PIR), a presence or an absence of root cause analysis (RCA), or the like, etc.) extracted from the current incident data object and primarily ranked past incident candidate data objects to identify the updated relevance scores of the subsequently ranked past incident candidate data objects.

At Block 610, the incident management server 200 includes means, such as the processor 202, input/output circuitry 204, memory 206, communications circuitry 208, past incident insight interface component circuitry 210, past incident candidate data object suggestion circuitry 212, or a combination thereof, to generate a past incident insight interface component comprising a past incident candidate data object suggestion set, the past incident candidate data object suggestion set listing one or more of the subsequently ranked past incident candidate data objects.

At Block 612, the incident management server 200 includes means, such as the processor 202, input/output circuitry 204, memory 206, communications circuitry 208, past incident insight interface component circuitry 210, past incident candidate data object suggestion circuitry 212, or a combination thereof, to output the past incident insight interface component for rendering to an incident alert management user interface of a computing device associated with the past incident insight interface component request.

Referring now to FIG. 7, an example process 700 for identifying one or more incident category(ies) of the current incident data object is provided. The inventors have determined that understanding the ongoing incident that is being investigated may be desirable and advantageous in order to improve the relevance of the past incident suggestions. At Block 702, the incident management server 200 includes means, such as the processor 202, input/output circuitry 204, memory 206, communications circuitry 208, past incident insight interface component circuitry 210, past incident candidate data object suggestion circuitry 212, or a combination thereof, to extract at least the incident title from the current incident data object. For example, the incident management server 200 may programmatically parse the text string of the current incident data object to segregate and extract the incident title. In some embodiments, one or more semantic parsers may be utilized to segregate the incident title.

At Block 704, the incident management server 200 includes means, such as the processor 202, input/output circuitry 204, memory 206, communications circuitry 208, past incident insight interface component circuitry 210, past incident candidate data object suggestion circuitry 212, or a combination thereof, to identify one or more incident category(ies) of the current incident data object. For example, the incident management server 200 may comprise or communicate with an incident categorization machine learning model to generate one or more incident categories. In a non-limiting embodiment, the incident categorization machine learning model may be a clustering machine learning model in accordance with one or more clustering algorithms, wherein the clustering machine learning model may generate one or more incident category clusters based on a plurality of historical or past incident data objects accessed by the incident management server 200. For example, the plurality of past incident data objects may be stored in the incident management repository 215. Each incident category cluster may be annotated as a potential incident category. For example, non-limiting examples of potential incident categories include “infrastructure”, “security”, “changes and deployments”, “data and tools”, “reliability issues”, “performance issues”, and “other”. In some embodiments, additional pre-defined categories may be added, for example through user feedback as described herein, as incident categories.

In some embodiments, the incident management server 200 may use the extracted text of the incident title of the current incident data object from Block 702 as input to a natural language processing machine learning model. For example, the incident management server 200 may comprise or communicate with (e.g., transmit one or more application programming interface (API) calls) a natural language processing machine learning model to generate and/or output a natural language feature data object (e.g., a feature vector) by performing one or more natural language processing operations on the extracted text. In some embodiments, the natural language processing machine learning model is a transformer-based learning model that has been trained to output sentence features (i.e., numerical representation of text). That is, the transformer-based learning model, such as a Google® Universal Sentence Encoder (USE) model, encodes the extracted text from the incident title field of the current incident data object into a high-dimensional feature vector, which can be used to identify one or more of the generated incident categories for the current incident data object. By applying the hierarchical clustering method to the past incident data objects, a domain-specific understanding of the current incident data object can be determined, thereby improving the relevance of the past incident suggestions. The current incident data object may be associated with the identified one or more incident category(ies). Additionally or alternatively, in some embodiments, such incident category prediction may be done using, for example, BART-large-mnli, a model which may be trained to understand if the incident title of the current incident data object supports the predefined incident categories or rejects it (e.g., a zero-shot classification or classification with zero training data).

Referring now to FIG. 8, an example process 800 for identifying the past incident candidate data object set is provided. At Block 802, the incident management server 200 includes means, such as the processor 202, input/output circuitry 204, memory 206, communications circuitry 208, past incident insight interface component circuitry 210, past incident candidate data object suggestion circuitry 212, or a combination thereof, to filter the plurality of past incident data objects based on at least the identified incident category(ies) of the current incident data object in Block 704. In other words, the incident management server 200 excludes or disregards those past incident data objects that do belong to any of the identified incident category(ies) of the current incident data object.

At Block 804, the incident management server 200 includes means, such as the processor 202, input/output circuitry 204, memory 206, communications circuitry 208, past incident insight interface component circuitry 210, past incident candidate data object suggestion circuitry 212, or a combination thereof, to identify the past incident data objects associated with the same incident category(ies) as the identified incident category(ies) of the current incident data object (e.g., as identified in Block 704) as the past incident candidate data object set. In this regard, the reduced search space advantageously enables the improved relevance of the past incident suggestions, and further advantageously optimizes search latency and conserves computing system resources that would otherwise be unnecessarily expended to query the entirety of the past incident data objects for each computing system service in a computing environment. For example, in at least one non-limiting example of over 20,000 total past incident data objects and an example identified incident category including around 3,000 past incident data objects, by filtering out (e.g., excluding or disregarding) those past incident data objects that do belong to the example identified incident category, a reduction of around 85% can be realized in the search space and noise.

Referring now to FIG. 9, an example process 900 for determining a primary ranking of the past incident candidate data object set or a subset thereof is provided. At Block 902, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine a similarity score for each of the past incident candidate data objects of the past incident candidate data object set as compared to the current incident data object. For example, in some embodiments, based on the extracted text of the incident titles from incident data objects as input, the incident management server 200 may comprise or communicate with (e.g., transmit one or more application programming interface (API) calls) a natural language processing machine learning model to generate and/or output a natural language feature data object (e.g., a feature vector) by performing one or more natural language processing operations on the extracted text. In some embodiments, the natural language processing machine learning model is a transformer-based learning model that has been trained to output sentence features (i.e., numerical representation of text). That is, the transformer-based learning model, such as a Google® Universal Sentence Encoder (USE) model and/or Multi-QA-miniLM, encodes extracted text from the incident title fields of the current incident data object and the past incident candidate data objects of the past incident candidate data objects into high-dimensional feature vectors. For example, the transformer-based learning model may use any algorithm or technique utilized to generate a data construct or data object formatted for entry into a machine learning model training module or classifier by representing entire sentences and their semantic information as high-dimensional feature vectors. The algorithm or technique may include receiving entire sentences from a document or text string (e.g., incident data object), such that the technique preserves the auxiliary details from the incident data object when generating a machine learning model. Such high-dimensional feature vectors can then be used for determining semantic similarity of the past incident candidate data objects of the past incident candidate data objects to the current incident data object. For example, in some embodiments, the cosine distance may be used as a similarity metric to identify those past incident candidate data objects that are closest to the current incident data object.

At Block 904, the incident management server 200 includes means, such as the processor 202, input/output circuitry 204, memory 206, communications circuitry 208, past incident insight interface component circuitry 210, past incident candidate data object suggestion circuitry 212, or a combination thereof, to compare the similarity score for each of the past incident candidate data objects of the past incident candidate data object set to a predetermined threshold.

At Block 906, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine a past incident candidate data object subset of the past incident candidate data object set, wherein the past incident candidate data object subset comprises the past incident candidate data objects having similarity scores that satisfy the predetermined threshold. For example, in some embodiments, the past incident candidate data object subset may comprise the past incident candidate data objects having a similarity score of more than 0.7. In other words, in this non-limiting example, the past incident candidate data objects having a similarity score of less than 0.7 may be removed from consideration in order to reduce the noise and irrelevant candidates.

At Block 908, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine a recency score for each past incident candidate data object of the past incident candidate data object subset. In some embodiments, the recency score of a past incident candidate data object may be calculated based on a timestamp field of the past incident candidate data object. For example, the creation timestamp field, which indicates the creation time and date of past incident candidate data object, may be used to determine if the past incident candidate data object is recent (e.g., less than 6 months old), not too recent (e.g., 6-12 months), or old (e.g., more than 12 months old). Because the underlying code and/or features of a computing system service may change, although a past incident candidate data object may be highly similar, it may not be as relevant if the underlying code and/or features of the computing system service have changed considerably. Additionally or alternatively, other timestamp field(s) may be used by the incident management server 200 to determine the recency score. For example, the updatedat timestamp field may be used. That is, in a non-limiting example, a successful resolution or completion of a past incident may help in understanding the relevancy of the past incident to the current incident data object (e.g, if an incident was completed successfully in less time and it has a high similarity with the current incident data object, then the incident management server 200 may be able to boost the relevance score so that the incident management/responder can use that particular past incident to solve the current incident data object faster).

At Block 910, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine a relevance score for each past incident candidate data object of the past incident candidate data object subset. In some embodiments, the relevance score of the past incident candidate data object may be an aggregate of the similarity score and the recency score of the past incident candidate data object.

At Block 912, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine the primary ranking of the past incident candidate data object subset based on at least the relevance score of each past incident candidate data object of the past incident candidate data object subset. For example, the incident management server 200 may comprise or communicate with a candidate ranking machine learning model to determine a primary ranking of the past incident candidate data object subset.

Referring now to FIG. 10, an example process 1000 for determining one or more subsequent rankings of the primarily ranked past incident candidate data objects is provided. At Block 1002, the incident management server 200 includes means, such as the processor 202, input/output circuitry 204, memory 206, communications circuitry 208, past incident insight interface component circuitry 210, past incident candidate data object suggestion circuitry 212, or a combination thereof, to extract one or more incident attributes or fields (e.g., optional fields of the incident objects) from each of the current incident data object and the primarily ranked past incident candidate data objects. For example, the incident management server 200 may extract a faulty service identifier, a service dependency of the faulty service identifier (e.g., a team member identifier), an incident description, an incident priority level, a presence or an absence of a post incident report (PIR), a presence or an absence of root cause analysis (RCA), or the like from the current incident data object and the primarily ranked past incident candidate data objects.

At Block 1004, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine an updated relevance score for each of the primarily ranked past incident candidate data objects. In some embodiments, the incident management server 200 may apply a machine learning model to determine the updated relevance scores. For example, the incident management server 200 may use the extracted incident attributes or fields from Block 1002 as input to a decision tree-based ranker machine learning model that is trained to output updated relevance scores. Additionally or alternatively, the incident management server 200 may apply a CrossEncoder which may place or apply an emphasis on relative rankings of a plurality of incident candidate data objects (e.g., as opposed to ranking each incident candidate data object individually).

At Block 1006, the incident management server 200 includes means, such as the processor 202, input/output circuitry 204, memory 206, communications circuitry 208, past incident insight interface component circuitry 210, past incident candidate data object suggestion circuitry 212, or a combination thereof, to determine one or more subsequent rankings of the past incident candidate data object subset based on at least the updated relevance score of each past incident candidate data object of the past incident candidate data object subset.

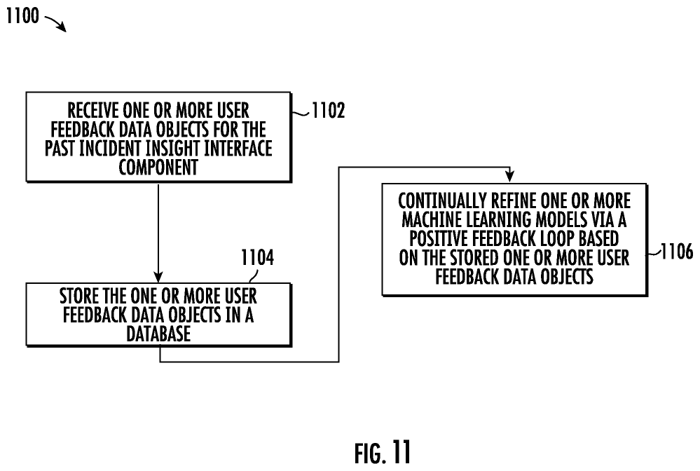

In some embodiments, the incident management server 200 may provide mechanisms to update one or more of the machine learning model(s) based on feedback from one or more users. Referring now to FIG. 11, an example process 1100 for retraining one or more machine learning models based on feedback from one or more users is provided. At Block 1102, the incident management server 200 includes means, such as the processor 202, input/output circuitry 204, memory 206, communications circuitry 208, past incident insight interface component circuitry 210, past incident candidate data object suggestion circuitry 212, or a combination thereof, to receive one or more user feedback data objects for the past incident insight interface component. For example, in some embodiments, the past incident insight interface component comprising the past incident candidate data object suggestion set may be configured to receive one or more user feedback data objects associated with the subsequently ranked past incident candidate data object(s) listed therein. That is, the past incident insight interface component may be rendered to an incident alert management user interface of a computing device and, in response to receiving user interaction with, for example, one or more feedback actuator buttons, the computing device may transmit one or more user feedback data objects to the incident management server 200. Accordingly, in some embodiments, the incident management server 200 may be configured to monitor for, detect, and/or receive such user feedback data object(s). As described herein, a user feedback data object may be any one or more of a click, dwell, explicit feedback, etc.

At Block 1104, the incident management server 200 includes means, such as the processor 202, input/output circuitry 204, memory 206, communications circuitry 208, past incident insight interface component circuitry 210, past incident candidate data object suggestion circuitry 212, or a combination thereof, to store the one or more user feedback data objects in a database (e.g., incident management repository 215).

At Block 1106, the incident management server 200 includes means, such as the processor 202, input/output circuitry 204, memory 206, communications circuitry 208, past incident insight interface component circuitry 210, past incident candidate data object suggestion circuitry 212, or a combination thereof, to continually refine one or more machine learning models via a positive feedback loop based on the stored one or more user feedback data objects. For example, the stored user feedback data object(s) can be used to retrain at least one of the machine learning model(s) used and/or implemented by the incident management server 200 in order to continually improve the past incident data object suggestion sets generated and outputted by the incident management server 200.

In some embodiments, the incident management server 200 may provide mechanisms for generating and transmitting notifications (e.g., an invite) to team members. Referring now to FIG. 12, an example process 1200 for generating and transmitting notifications (e.g., an invite) to a team member is provided. At Block 1202, the incident management server 200 includes means, such as the processor 202, input/output circuitry 204, memory 206, communications circuitry 208, past incident insight interface component circuitry 210, past incident candidate data object suggestion circuitry 212, or a combination thereof, to receive a team member data object. In some embodiments, a team member data object may be associated with a selected subsequently ranked past incident candidate data object. For example, a team member data object may be generated by a computing device based on user interaction with a team member identifier rendered in association with a selected subsequently ranked past incident candidate data object. The user interaction (e.g., selection of the team member identifier) may indicate the user's intention to invite the team member associated with the team member identifier of the past incident data object to assist with and/or be assigned the current incident data object.

At Block 1204, the incident management server 200 includes means, such as the processor 202, input/output circuitry 204, memory 206, communications circuitry 208, past incident insight interface component circuitry 210, past incident candidate data object suggestion circuitry 212, or a combination thereof, to generate a notification. For example, in response to receiving the team member data object, the incident management server 200 may be configured to programmatically generate a notification that invites the team member associated with the team member identifier of the past incident data object to assist with and/or be assigned the current incident data object.

At Block 1206, the incident management server 200 includes means, such as the processor 202, input/output circuitry 204, memory 206, communications circuitry 208, past incident insight interface component circuitry 210, past incident candidate data object suggestion circuitry 212, or a combination thereof, to transmit the notification to a computing device associated with the team member identifier.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. Thus, for example, references to “an image” includes a combination of two or more images and references to “a graphic” includes different types and/or combinations of graphics.

### Definitions

The following explanations of terms are provided to better describe the present disclosure and to guide those of ordinary skill in the art in the practice of the present disclosure.

The term “enterprise software platform” refers to a software platform comprising one or more types of software applications (e.g., monolithic software applications and/or service-oriented software applications). A “monolithic software application” refers to a single-tiered architecture in which the front-end and back-end systems are combined into a single platform. Monolithic software platforms are self-contained in that they can perform each operation needed to complete their intended purpose or function. A “service-oriented software application” is characterized by large networks of interdependent services and microservices that support a myriad of software features and applications. Such service-oriented software applications may be nimble, highly configurable, and enable robust collaboration and communication between users at individual levels, team levels, and enterprise levels. A service-oriented software application is configured to support hundreds of software applications and hundreds of thousands of features. Those applications and features could be supported by thousands of services and microservices that exist in vast and ever-changing interdependent layers. In a service-oriented software application, at any given time, a great number of software development teams may be constantly, yet unexpectedly, releasing code updates that change various software services, launch new software services, change existing features of existing software applications, add new software applications, add new features to existing software applications, and/or the like. An enterprise software platform includes computing environment(s), a software monitoring data management system, client devices, and a network.

The term “software monitoring data management system” refers to any software platform(s) and associated hardware configured to the operational state of one or more software applications, services, microservices, features, and/or other similar mechanisms within an enterprise software network. In some embodiments, a software monitoring data management system is configured to generate and/or transmit incidents and alerts in the form of incident data objects. A software monitoring data management system is configured to detect incidents, alerts, warnings, problems, errors, and/or issues. For example, a software monitoring data management system may comprise a software product such as Opsgenieß by Atlassian® and/or Jira Service Management® by Atlassian®. Example software monitoring data management systems comprise supporting server(s) and repositor(ies), and in some embodiments, are further configured to engage with computing environment(s), external resources, and/or external applications.

The term “incident management server” refers to a software platform and associated hardware that is configured to manage various aspects associated with the incident data objects of the software monitoring data management system, including but not limited to, managing past incident insight interface components and associated functionality of the software monitoring data management system. The incident management server is accessible via one or more computing devices, is configured to receive various requests (e.g., past incident insight interface component requests and/or the like), and access one or more data repositories such as an incident management repository. The functionality of the incident management server may be provided via a single server or collection of servers having a common functionality, or the functionality of the incident management server may be segmented among a plurality of servers or collections of servers (e.g., a cloud networking environment, microservices, and/or the like) performing subsets of the described functionality of the incident management server. The incident management server is configured to generate and/or output past incident insight interface components, manage past incident insight interface component requests, identify and/or determine past incident candidate data objects, past incident candidate data object sets, past incident candidate data object subsets, and/or past incident candidate data object suggestion sets, determine primary rankings and/or subsequent rankings of past incident candidate data objects, continually refine one or more machine learning models (e.g., based on user feedback data objects), among other things. For example, the incident management server is configured to make a suggestion or a prediction of a similar past incident data object(s), execute action(s), initiate response(s) based on the reception of a past incident insight interface component request, categorize incidents, and/or provide incident notifications, among other things.

The term “incident alert management user interface” refers to a graphical user interface of a software monitoring data management system that is configured to enable users to view and engage with one or more incident data objects and/or the software monitoring data management system. An incident alert management user interface is rendered to a client device based on data and instructions provided by the software monitoring data management system. In some embodiments, such data and instructions are facilitated by a dedicated software application running on the client device. In other embodiments, such data and instructions are provided through a web browser running on the client device. A non-limiting example of incident alert management user interface is depicted as 500 in FIG. 5.

The term “past incident insight interface component” refers to a graphical user interface or sub-user interface of a software monitoring data management system that is configured to comprise and/or display a listing of a past incident candidate data object suggestion set, the past incident candidate data object suggestion set listing one or more of subsequently ranked past incident candidate data objects. A past incident insight interface component is rendered to a client device based on data and instructions provided by the software monitoring data management system (e.g., incident management server). In some embodiments, such data and instructions are facilitated by a dedicated software application running on the client device. In other embodiments, such data and instructions are provided through a web browser running on the client device. In some embodiments, the past incident insight interface component is configured to display one or more levels of information. For example, FIG. 4A illustrates an example embodiment of a past incident insight interface component 400 exposing a first level or summary presentation of information and FIG. 4B illustrates an example embodiment of a past incident insight interface component 400 exposing a second level or detailed presentation of information in association with a selected past incident data object.

The term “computing environment” refers to a plurality of computing system services that provide a functionality or multiple functionalities alone and/or in conjunction with one another. A computing environment includes at least one computing system service that is dependent on another computing system service within the computing environment. Any number of computing system services within a computing environment may be dependent on any number of other computing system services within the environment.

The term “computing system service” refers to one or more computer device(s) embodied in hardware, software, firmware, and/or any combination thereof, that provides particular functionality. A computing system service is connected with a computing device associated with an end user or another computing system service to operate as a dependency for the other computing device. Non-limiting examples of a computing system service includes one or more application server(s), end terminal(s), backend repository/repositories, and/or other computing device(s) embodying an application service or a microservice.

The term “dependency” refers to a state of reliance by a first computing system service on another computing system service for the first computing system service to provide a particular portion of functionality. A first computing system service that relies on a dependency to a second computing system service (e.g., the second system service is a dependency of the first system service) indicates that the second computing system service must be functioning at least in part for the first computing system service to provide the particular portion of functionality that relies on the second system service. A computing system service that is “dependent on” a second computing system service has a dependency to the second computing system service.

The term “incident identifier” refers to one or more items of data by which an incident data object may be identified within a software monitoring data management system. For example, an incident identifier may comprise text string(s), numerical character(s), alphabetical character(s), alphanumeric code(s), American Standard Code for Information Interchange (ASCII) character(s), a pointer, an Internet Protocol (IP) address, a MAC address, a memory address, other unique identifier, or a combination thereof.

The term “faulty service identifier” refers to one or more items of data by which a faulty service associated with an incident data object may be identified within a software monitoring data management system. For example, a faulty service identifier may comprise text string(s), numerical character(s), alphabetical character(s), alphanumeric code(s), American Standard Code for Information Interchange (ASCII) character(s), a pointer, an Internet Protocol (IP) address, a MAC address, a memory address, other unique identifier, or a combination thereof.

The term “team member identifier” refers to one or more items of data by which a team member may be identified within a software monitoring data management system. For example, a team member identifier may comprise text string(s), numerical character(s), alphabetical character(s), alphanumeric code(s), American Standard Code for Information Interchange (ASCII) character(s), a pointer, an Internet Protocol (IP) address, a MAC address, a memory address, other unique identifier, or a combination thereof.

The term “team member data object” refers to any data construct and/or data object generated by and/or received by an incident management server indicating a team member identifier to which a notification is requested to be transmitted in association with an incident data object.

The term “incident data object” refers to any data construct and/or data object generated by and/or received by an incident management server indicating the status and/or operating functionality of a component, module, and/or device within the enterprise software platform. Such operating functionality may include indicators regarding the performance of a component (e.g., whether the component and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.). Incident data objects include incident attributes as defined herein. An incident data object may be transmitted to specific interconnected components on the enterprise software network. Alternatively, or additionally, an incident data object may be broadcast to the plurality of interconnected components. In some embodiments, one or more incident data objects may be stored in an incident corpus (e.g., incident management repository) for use in training one or more message machine learning models.

The term “attributes” or “incident attributes” refers to any text, identifiers, metadata, or other incident-related characteristics or features that are transmitted as part of an incident data object. Example incident attributes include, but are not limited to, an incident identifier, an incident title, a priority, an incident description, a faulty service identifier, a project identifier, a time or date of the incident, and other properties related to the incident data object.

The term “incident management repository” refers to a location, such as a database stored on a memory device, which is accessible by one or more computing devices for retrieval and storage of data associated with past incident insight interface components. For example, the incident management repository includes one or more of incident data objects (e.g., past and/or current), incident attribute(s), incident identifier(s), incident title(s), incident description(s), faulty service identifier(s), affected product identifier(s), PIRs, RCAs, team member identifier(s), team member data object(s), creation date(s), visual emphasis element(s), priority(ies), past incident candidate data object set(s), past incident candidate data object subset(s), past incident candidate data object suggestion set(s), user feedback data object(s), incident categories, similarity score(s), recency score(s), relevance score(s), updated relevance score(s), ranking(s), predetermined threshold(s), and/or the like. The incident management repository may be a dedicated device and/or a part of a larger repository. The incident management repository may be dynamically updated or be static. In some embodiments, the incident management repository is encrypted in order to limit unauthorized access of such incident data.

The term “user feedback data object” refers to a data object that is generated by a client computing device and transmitted to incident management server. The user feedback data objects are generated based on end-user interactions with the client computing device in relation to ranked past incident candidate data objects rendered to a past incident insight interface component. For example, a user interface displayed by the client computing device may enable end-users to rate and/or otherwise provide feedback on the relevancy and/or similarity of a selected past incident data object and/or a past incident candidate data object suggestion set, and the user-provided ratings may then be used to determine user feedback data objects. In some embodiments, the user feedback data objects are used to retrain at least one machine learning model.

The term “text string” refers to a data construct and/or data object comprising a sequence of one or more characters. A number of incident attributes comprise labels and/or values represented as text strings, including but not limited to the incident identifier, the priority, the incident title, the incident description, the time and/or date of the incident, and the like.

The term “category” or “incident category” refers to any category, classification, label, or group having particular shared characteristics. Incident categories are defined to classify and group incidents or incident data objects. For example, non-limiting examples of potential incident categories include “infrastructure”, “security”, “changes and deployments”, “data and tools”, “reliability issues”, “performance issues”, and “other”. The classification of a incident data object into a category, an incident category, or a pre-defined category affects various aspects of determining suggested past incidents. For example, a past incident data object may be included or excluded in further determination and/or ranking of past incident data objects dependent on the incident category associated with the past incident data object.

“Notification” refers to electronically managed data that is human-readable and/or machine-processable by a client device.

The terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

A “computer-readable storage medium,” which refers to a physical storage medium (e.g., volatile or non-volatile memory device), may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “database,” “resource,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSql database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### CONCLUSION

While the present disclosure has been particularly described in conjunction with specific examples, it is evident that many alternatives, modifications, and variations will be apparent to those skilled in the art in light of the foregoing descriptions and the associated drawings. It is therefore to be understood that the present disclosure is not to be limited to the specific embodiments disclosed and it is contemplated that the appended claims will embrace any such alternatives, modifications, and variations. That is, while various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. As one of ordinary skill in the art will readily appreciate form the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps and the scope of protection is not limited by the description set out above. Moreover, although specific terms are employed herein, they are used in a generic and descriptive sense only and not for purposes of limitation.

1. An apparatus for outputting a past incident insight interface component in a software monitoring data management system, the apparatus comprising at least one processor, and at least one memory including program code, the at least one memory and the program code configured to, with the at least one processor, cause the apparatus to at least:
detect a past incident insight interface component request in response to user interaction with a software monitoring data management system, wherein the past incident insight interface component request is associated with a current incident data object;
identify a past incident candidate data object set based on the current incident data object;
determine a primary ranking of the past incident candidate data object set or a subset thereof;
determine one or more subsequent rankings of the primarily ranked past incident candidate data objects of the past incident candidate data object set or the subset thereof;
generate a past incident insight interface component comprising a listing of a past incident candidate data object suggestion set, the past incident candidate data object suggestion set listing one or more of the subsequently ranked past incident candidate data objects; and
output the past incident insight interface component for rendering to an incident alert management user interface of a computing device associated with the past incident insight interface component request.

2. The apparatus of claim 1, wherein the past incident insight interface component is configured to expose a first or summary level of information for at least a selected subsequently ranked past incident candidate data object of the past incident candidate data object suggestion set.

3. The apparatus of claim 2, wherein the first or summary level of information comprises one or more of an incident title, a team member identifier, a creation date, an incident identifier, or a visual emphasis element associated with a priority of the selected subsequently ranked past incident candidate data object.

4. The apparatus of claim 3, wherein the program code is further configured to, with the at least one processor, cause the apparatus to at least:
receive a team member data object associated with a selected subsequently ranked past incident candidate data object, wherein the team member data object is based on user interaction with the team member identifier rendered in association with the selected subsequently ranked past incident candidate data object;
generate a notification in response to receiving the team member data object; and
transmit the notification to a computing device associated with the team member identifier.

5. The apparatus of claim 1, wherein the past incident insight interface component is configured to expose a second or detailed level of information for at least one of the subsequently ranked past incident candidate data objects of the past incident candidate data object suggestion set.

6. The apparatus of claim 5, wherein the second or detailed level of information comprises one or more of a faulty service identifier, an affected product identifier, or a link to a post incident report associated with the at least one subsequently ranked past incident candidate data object.

7. The apparatus of claim 1, wherein the past incident insight interface component comprises one or more feedback actuator buttons associated with at least one of the subsequently ranked past incident candidate data objects, the one or more feedback actuator buttons configured for user interaction.

8. The apparatus of claim 7, wherein the program code is further configured to, with the at least one processor, cause the apparatus to at least:
receive one or more user feedback data objects associated with the at least one of the subsequently ranked past incident candidate data objects, wherein the one or more user feedback objects are based on user interaction with at least one of the one or more feedback actuator buttons;
store the one or more user feedback data objects in a database; and
continually refine one or more machine learning models via a positive feedback loop based on the stored one or more user feedback data objects.

9. The apparatus of claim 1, wherein identifying the past incident candidate data object set based on the current incident data object comprises:
identifying one or more incident categories of the current incident data object;
accessing a plurality of past incident data objects;
filtering the plurality of past incident data objects based on at least the identified one or more incident categories of the current incident data object; and
identifying the past incident data objects associated with the same incident category(ies) as the identified one or more incident categories of the current incident data object as the past incident candidate data object set.

10. The apparatus of claim 9, wherein identifying the one or more incident categories of the current incident data object comprises:
causing input of the plurality of past incident data objects to an incident categorization machine learning model, the incident categorization machine learning model generating a plurality of incident categories based on the plurality of past incident data objects;
extracting at least an incident title from the current incident data object; and
associating one or more incident categories of the plurality of incident categories with the current incident data object based at least in part on the extracted incident title.

11. The apparatus of claim 10, wherein the incident categorization machine learning model comprises a clustering machine learning model in accordance with one or more clustering algorithms.

12. The apparatus of claim 1, wherein determining the primary ranking of the past incident candidate data object set or a subset thereof comprises:
determining the primary ranking of the past incident candidate data object subset based on at least a relevance score of each past incident candidate data object of the past incident candidate data object subset.

13. The apparatus of claim 12, wherein determining the primary ranking of the past incident candidate data object subset based on at least the relevance score of each past incident candidate data object of the past incident candidate data object subset comprises:
determining a similarity score, as compared to the current incident data object, for each past incident candidate data object of the past incident candidate data object set;
comparing the similarity score for each past incident candidate data object of the past incident candidate data object set to a predetermined threshold;
determining the past incident candidate data object subset, wherein the past incident candidate data object subset comprises the past incident candidate data objects of the past incident candidate data object set having similarity scores that satisfy the predetermined threshold;
determining a recency score for each past incident candidate data object of the past incident candidate data object subset; and
determining the relevance score for each past incident candidate data object of the past incident candidate data object subset.

14. The apparatus of claim 13, wherein the relevance score for each past incident candidate data object is an aggregate of the similarity score and the recency score of the past incident candidate data object.

15. The apparatus of claim 1, wherein determining the one or more subsequent rankings of the primarily ranked past incident candidate data objects comprises:
extracting one or more incident attributes from each of the current incident data object and the primarily ranked past incident candidate data objects;
determining an updated relevance score for each of the primarily ranked past incident candidate data objects; and
determining the one or more subsequent rankings of the primarily ranked past incident candidate data objects of the past incident candidate data object subset based on at least the updated relevance score of each past incident candidate data object.

16. The apparatus of claim 15, wherein determining the updated relevance score for each of the primarily ranked past incident candidate data object comprises inputting the extracted incident attributes to a decision tree-based ranker machine learning model that is trained to output the updated relevance scores.

17. A method for outputting a past incident insight interface component in a software monitoring data management system, the method comprising:
detecting a past incident insight interface component request in response to user interaction with the software monitoring data management system;
identifying a past incident candidate data object set;
determining a primary ranking of the past incident candidate data object set or a subset thereof;
determining one or more subsequent rankings of the primarily ranked past incident candidate data objects of the past incident candidate data object set or the subset thereof;
generating a past incident insight interface component comprising a listing of a past incident candidate data object suggestion set; and
outputting the past incident insight interface component for rendering to an incident alert management user interface of a computing device associated with the past incident insight interface component request.

18. The method of claim 17, wherein determining the primary ranking of the past incident candidate data object set or a subset thereof is based on at least a relevance score of each past incident candidate data object of the past incident candidate data object subset, the method further comprising:
determining a similarity score, as compared to the current incident data object, for each past incident candidate data object of the past incident candidate data object set;
comparing the similarity score for each past incident candidate data object of the past incident candidate data object set to a predetermined threshold;
determining the past incident candidate data object subset, wherein the past incident candidate data object subset comprises the past incident candidate data objects of the past incident candidate data object set having similarity scores that satisfy the predetermined threshold;
determining a recency score for each past incident candidate data object of the past incident candidate data object subset; and
determining the relevance score for each past incident candidate data object of the past incident candidate data object subset.

19. The method of claim 17, wherein determining the one or more subsequent rankings of the primarily ranked past incident candidate data objects comprises:
extracting one or more incident attributes from each of a current incident data object and the primarily ranked past incident candidate data objects;
determining an updated relevance score for each of the primarily ranked past incident candidate data objects; and
determining the one or more subsequent rankings of the primarily ranked past incident candidate data objects of the past incident candidate data object subset based on at least the updated relevance score of each past incident candidate data object.

20. A computer program product for outputting a past incident insight interface component in a software monitoring data management system, the computer program product comprising at least one non-transitory computer-readable storage medium having computer-readable program code portions stored therein, the computer-readable program code portions comprising an executable portion configured to:
detect a past incident insight interface component request in response to user interaction with a software monitoring data management system, wherein the past incident insight interface component request is associated with a current incident data object;
identify a past incident candidate data object set based on the current incident data object;
generate a past incident insight interface component comprising a listing of a past incident candidate data object suggestion set, the past incident candidate data object suggestion set listing one or more ranked past incident candidate data objects; and
output the past incident insight interface component for rendering to an incident alert management user interface of a computing device associated with the past incident insight interface component request.
